(19) United States
(12) Patent Application Publication
(10) Pub. No.: US 2014/0088522 A1
(43) Pub. Date: Mar. 27, 2014

(54) METHOD OF TREATING THE SCALP

(71) Applicants: Stefania Nuzzo, Paris (FR); Gabin Vic, Semoy (FR); Fabrice Osolin, Franconville (FR); Maryse Chaisy, Fresneaux-Montchevreuil (FR)

(72) Inventors: Stefania Nuzzo, Paris (FR); Gabin Vic, Semoy (FR); Fabrice Osolin, Franconville (FR); Maryse Chaisy, Fresneaux-Montchevreuil (FR)

(73) Assignee: L'OREAL, Paris (FR)

(21) Appl. No.: 14/110,600

(22) PCT Filed: Apr. 5, 2012
(86) PCT No.: PCT/IB2012/051694

§ 371 Date: Dec. 6, 2013

Related U.S. Application Data
(60) Provisional application No. 61/476,786, filed on Apr. 19, 2011.

(30) Foreign Application Priority Data
Apr. 8, 2011 (FR) 11 53106

(51) Int. Cl. A61H 7/00

(52) U.S. Cl. CPC A61H 7/005
USPC 604/290

(57) ABSTRACT

The present invention relates to a method of treating the scalp, the method comprising the following steps: •applying a composition to the scalp, the composition including at least one active ingredient selected from: •anti-dandruff agents; •anti-seborrheic agents; •soothing or anti-irritant agents; •exfoliating agents; and •anti-hairloss agents; and •moisturizing agents; and •performing a massage of the scalp by means of a motor-driven massage device (10, 20) that includes spikes (21) that are driven by an oscillating movement.

The present invention relates to methods, devices, and kits for treating the scalp.

Washing the scalp is a recurring act that consists in removing dirt, dandruff or scurf, and excess grease.

Until now, dealing with adhering dandruff has amounted to eliminating dandruff by exfoliating or to combating yeasts of the Malassezia species that give rise to such dandruff.

Hyper seborrhea is combated by means of shampoos or lotions.

In addition, for people who have sensitive scalps that are more prone to such difficulties, it is possible for them to apply soothing and/or anti-irritant agents, moisturizing agents, or agents for slowing hair loss.

Alternative solutions have been proposed that are for taking orally, making it possible to reinforce the natural defenses of the scalp, and to combat the proliferation of dandruff.

Tools for washing or massaging the scalp and the hair are known from WO 2008/054089 A, U.S. Pat. No. 6,283,930 B, JP 2005-046190 A, JP 2006-034941 A, RU 2 186 514 C, WO 92/18086 A, CN 201044658 Y, EP 0 446 495 A, JP 11070019 A, FR 2 729 075 A, and JP 2002-078761 A. U.S. Pat. No. 6,043,202 B discloses examples of kits for treating cradle cap, or infantile eczema.

Application EP 1 825 842 A describes a massage device for massaging the scalp while washing the hair, for example, and provides for simultaneous use of a shampoo.

US application No. 2009/0182249 A discloses a scalp massage device including a reservoir that is suitable for containing a liquid such as a shampoo or a lotion for stimulating hair growth. Various scalp massage devices are also disclosed in publications EP 1 972 317 A, EP 1 964 537 A, and EP 2 080 500 A.

A need exists to benefit from a method and a kit for treating the scalp, which method and kit make it possible, in particular, to wash dandruff away effectively, and to delay its reappearance over time.

First exemplary embodiments of the invention provide a cosmetic treatment method for treating the scalp, the method comprising the steps consisting in:
applying a composition to the scalp, the composition including at least one active ingredient selected from:
   anti-dandruff agents;
   anti-seborrheic agents;
   soothing or anti-irritant agents;
   exfoliating agents;
   anti-hairloss agents; and
   moisturizing agents; and
performing a massage of the scalp by means of a motor-driven massage device that includes spikes that are driven by an oscillating movement.

The scalp may be massaged by means of the motor-driven device after the composition of the invention has been applied to the scalp, and preferably in the presence of said composition.

The scalp may be massaged by means of the motor-driven device before the composition of the invention is applied to the scalp, e.g. less than 60 minutes before. The massage is thus performed preferably in the presence of a composition that does not contain the active ingredient of the invention, and that may contain a surfactant.

Preferably, the massage device is characterized by the fact that it includes: a flexible diaphragm carrying the spikes that are adapted to come into contact with the scalp; and a drive mechanism that enables the diaphragm to deform periodically so as to generate movement of the spikes in contact with the scalp.

The drive mechanism preferably includes a connecting rod that is driven in oscillating motion, which connecting rod is connected at one end to a member that is rotated by an electric motor, and at its other end, it is connected directly or indirectly to the flexible diaphragm, in particular in a central region thereof.

The frequency of oscillation of the diaphragm preferably lies in the range 0.5 hertz (Hz) to 200 Hz, better in the range 1 Hz to 20 Hz, the limits of the ranges being included in the ranges.

The envelope surface defined by the free ends of the spikes may be a surface that is concave towards the scalp, having a radius of curvature that varies depending on how the diaphragm deforms.

While the diaphragm is oscillating, at least some spikes rub against the scalp. Scalp-treatment performance is obtained by the spikes rubbing against the scalp, in combination with the presence of the composition. The invention makes it possible to obtain a dandruff-treatment effect that is better than the effect obtained by hand.

The travel axis of the flexible diaphragm, i.e. the axis of the oscillating movement, may be substantially perpendicular to the scalp during massage. Preferably, the spikes are made out of a thermoplastic material.

The massage device is preferably applied to the scalp with a small amount of pressure.

In other exemplary embodiments the invention provides a cosmetic treatment method for treating the scalp comprising the steps consisting in:
applying a composition to the hair, the composition comprising one or more active ingredients selected from the following:
   hair conditioning agents;
   reducing agents;
   organic or inorganic bases;
   hair dyes;
   abrasive solid particles; and
   moisturizing agents; and
performing a massage of the scalp for a period of 1 minute to 5 minutes by means of a motor-driven massage device that includes spikes that are driven by an oscillating movement.

Other exemplary embodiments of the invention also provide a motor-driven massage device for implementing one of the above methods.

The invention also provides a motor-driven massage device including: a flexible diaphragm carrying the spikes that are adapted to come into contact with the scalp; a drive mechanism that enables the diaphragm to deform periodically so as to generate movement of the spikes in contact with the scalp; and a reservoir containing a composition for application, in the form of a pre-filled removable cartridge.

The active ingredients(s) may be applied alone or in combination with other ingredients. When applied in combination, the active ingredient(s) may preferably represent up to 50% by weight of the total weight of the composition, preferably up to 20% by weight of the total weight of the composition.

The active ingredient(s) of the invention may represent more than 0.001%, better more than 0.1%, better still more than 0.2%, and more particularly more than 0.5% by weight relative to the total weight of the composition.

### Active Ingredients

The composition applied to the scalp may contain at least one of the following active ingredients.

### Anti-Seborrheic Agents

The term “anti-seborrheic agent” means a compound that is capable of controlling the activity of the sebaceous glands.

An anti-seborrheic compound that is suitable for the invention may in particular be selected from: retinoic acid; benzoyl peroxide; sulfur; vitamin B6 (or pyridoxine); selenium chloride; sea fennel; mixtures of cinnamon, tea, and octanoylglycine extracts such as Sepicontrol A5 TEA® from the supplier Seppic; mixture of cinnamon, sarcosine, and octanoylglycine, sold in particular by the supplier SEPPIC under the trade name Sepicontrol A5®; zinc salts such as zinc gluconate, zinc pyrrolidonecarboxylate (or zinc pidolate), zinc lactate, zinc aspartate, zinc carboxylate, zinc salicylate, zinc cysteate; copper derivatives and in particular copper pidolate such as Cuivridone® by Solabia; extracts of plants of the species Arnica montana, Cinchona succirubra, Eugenia caryophyllata, Humulus lupulus, Hypericum perforatum, Mentha piperita, Rosmarinus officinalis, Salvia officinalis, and Thymus vulgaris, all sold for example by the supplier MARUZEN; extracts of meadowsweet (spiraea ulamaria) such as that sold under the trade name Sebonormine® by the supplier Silab; extracts of Laminaria saccharina (kelp) such as that sold under the trade name Phlorogine® by the supplier Biotechmarine; mixtures of extracts of burnet (Sanguisorba officinalis/Poterium officinale) roots, ginger (Zingiber officinalis) rhizomes, and cinnamon (Cinnamomum cassia) bark such as that sold under the trade name Sebustop® by the supplier Solabia; linseed extracts such as that sold under the trade name Linumine® by the supplier Lucas Meyer; Phellodendron extracts such as those sold under the trade name Phellodendron extract BG by the supplier Maruzen or Oubaku liquid B by the supplier Ichimaru Pharcos; mixtures of argan oil, of Serenoa serrulata (saw palmetto) extract, and of sesame seed extract, such as that sold under the trade name Regu SEB® by the supplier Pentapharm; mixtures of extracts of willow herb, Terminalia chebula, nasturtium and bioavailable zinc (microalgae) such as that sold under the trade name Seborilys® by the supplier Green tech; extracts of Pygeum afrianum such as that sold under the trade name Pygeum afrianum sterolic lipid extract by the supplier Euromed; extracts of Serenoa serrulata such as those sold under the trade name Viapure Sabal by the supplier Actives International, or those sold by the supplier Euromed; mixtures of extracts of plantain, Berberis aquifolium, and sodium salicylate such as that sold under the trade name Seboclear® by the supplier Rahn; clove extract such as that sold under the trade name Clove extract Powder by the supplier Maruzen; argan oil such as that sold under the trade name Lipofructyl® by Laboratoires Serobiologiques; lactic protein filtrates such as that sold under the trade name Normaseb® by the supplier Sederma; extracts of the alga Laminaria, such as that sold under the trade name Laminarghane® by the supplier Biotechmarine; oligosaccharides of the alga Laminaria digitata such as that sold under the trade name Phycosaccharide AC by the supplier Codif; extracts of cane sugar, such as that sold under the trade name Policasonol® by the supplier Sabinsa; sulfonated schist oil such as that sold under the trade name Ichtyol Pale® by the supplier Ichthyol; meadowsweet (spiraea ulmaria) extracts such as that sold under the trade name Cytobiol® Ulmaire by the supplier Libiol; sebacic acid, in particular sold in the form of a sodium polyacrylate gel under the trade name Sebosoft® by the supplier Sederma; glucomannans extracted from konjac tuber and modified with alkyl sulfonate chains, such as that sold under the trade name Biopol Beta by the supplier Arch Chemical; extracts of Sophora angustifolia, such as those sold under the trade name Sophora powder or Sophora extract by the supplier Bioland; extracts of Cinchona succirubra bark such as that sold under the trade name Red bark HS by the supplier Alban Muller; extracts of Quillaja saponaria such as that sold under the trade name Panama wood HS by the supplier Alban Muller; glycine grafted onto an undecylenic chain or onto a octanoyl chain, such as that sold under the trade name Lipacide UG OR, Lipacide C8G by the supplier Seppic; oleanolic acid and nordihydroguaiaretic acid mixture such as that sold in the form of a gel under the trade name AC.Net by the supplier Sederma; phthalimidoperoxyhexanoic acid; (C₁₂-C₁₃)trialkyl citrate sold under the trade name COSMACOL® ECI by the supplier Sasol; (C₁₄-C₁₅)trialkyl citrate sold under the trade name COSMACOL® ECL by the supplier Sasol; 10-hydroxydecanoic acid, and in particular mixtures of 10-hydroxydecanoic acid, sebacic acid, and 1,10-decanediol, such as that sold under the trade name Acnacidol® BG by the supplier Vincience; yeast protein hydrolysates such as ASEBIOL LS by COGNIS (mixed with vitamins); and mixtures thereof.

### Anti-Dandruff Agents

The term “anti-dandruff agent” means a compound that is capable of preventing the appearance of dandruff, of reducing the amount thereof, and/or of making it disappear completely.

Anti-dandruff agents that are suitable for the invention may in particular be selected from:
derivatives of 1-hydroxy-2-pyridone such as 1-hydroxy-4-methyl-2-pyridone, 1-hydroxy-6-methylpyridone, 1-hydroxy-4,6-dimethyl-2-pyridone, 1-hydroxy-4-methyl-6-(2,4,4-trimethylpentyl)-2-pyridone, 1-hydroxy-4-methyl-6-cyclohexyl-2-pyridone, 1-hydroxy-4-methyl-6-(methyl-cyclohexyl)-2-pyridone, 1-hydroxy-4-methyl-6-(2-bicyclo[2,2,1]heptyl)-2-pyridone, 1-hydroxy-4-methyl-6(4-methylphenyl)-2-pyridone, 1-hydroxy-4-methyl-6[1-[4-nitrophenoxy]-butyl]-2-pyridone, 1-hydroxy-4-methyl-6-(4-cyanophenoxymethyl-2-pyridone), 1-hydroxy-4-methyl-6-(phenylsulfonylmethyl)-2-pyridone, 1-hydroxy-4-methyl-6-(4-bromobenzyl)-2-pyridone and salts thereof; By way of preferred derivative of 1-hydroxy-2-pyridone, mention may be made of the composition sold by HOECHST under the trade name octopyrox (1-hydroxy-4-methyl-6-(2,4,4-trimethylpenthyl)-2-pyridone, monoethanolamine salt;
pyridinethione salts, in particular calcium, magnesium, barium, strontium, zinc, cadmium, tin, and zirconium salts. Zinc pyridinethione salt is particularly preferred. Zinc pyridinethione salt is sold in particular under the trade name zinc omadine by OLIN;
trihalogeno carbamide of formula:

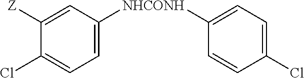

in which Z represents a halogen atom such as chlorine or a C₁-C₄ trihalogenoalkyl group such as CF₃;
triclosan represented by the formula:

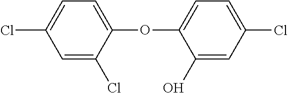 [SMILES: Oc1cc(Cl)ccc1Oc1ccc(Cl)cc1Cl]

azole compounds such as climbazole, ketoconazole, clotrimazole, econazole, isoconazole, and miconazole;
anti-fungal polymers such as amphotericin B or nystatin;
selenium sulfides, in particular those of formula SₓSe₈₋ₓ, in which x lies in the range 1 to 7;
sulfur in its various forms, cadmium sulfide, allantoin, coal or wood tars, and derivatives thereof, in particular juniper tar oil, undecylenic acid, fumaric acid, allylamines such as terbinafine; and
ellagic acid.

Anti-Hairloss Agents

These compounds are in particular selected from: vasodilators such as nicotinic acid esters, including in particular tocopheryl nicotinate, benzyl nicotinate, and C₁-C₆ alkyl nicotinates such as methyl nicotinate or hexyl nicotinate.

Other active compounds for limiting hair loss that may be mentioned are: aminexil or Mex (2,4 diamino pyrimidine 3N oxyde); O-acyl derivatives obtained by partial or total esterification of vitamin F by glucose, as described in application EP 1 688 128; and mixtures thereof.

### Anti-Irritant/Soothing Agents

Anti-irritant/soothing active ingredients that may be mentioned are: anti-inflammatory agents; α-bisabolol; benzydamine; salicylic acid.

Other than the above-mentioned anti-inflammatory agents, mention may also be made of: strontium salts; β-glycyrrhetinic acid; glycyrrhizic acid; azulene; essential oils; and extracts of chamomile, oats, aloe vera, verbena, tilia, and licorice.

### Exfoliating Agents

### These are Preferable Abrasive Solid Particles

The term “abrasive solid particles” means particles that present hardness that is greater than or equal to the hardness of the hair. For example, the abrasive solid particles may have a hardness that is greater than or equal to 3 on the Mohs scale, or greater than or equal to 4, e.g. greater than or equal to 5 on the Mohs scale.

The solid particles may be selected from natural materials, in particular of mineral or vegetable origin, or from synthetic materials. By way of example, the abrasive solid particles may be selected from the following materials, this list not being limiting:
inorganic and/or metallic particles such as: boron nitride, in body-centered cubic form (Borazon®); aluminosilicate; zircon; mixed oxides of aluminum such as emery; zinc oxide; aluminum oxides such as aluminas or corundum; titanium oxide; titanium oxide coated mica; carbides, in particular silicon carbide (carborundum); or other metal oxides; metals, and metal alloys such as iron shot, steel shot, and in particular perlite; silicates such as glass, quartz, or sand; calcium carbonate (e.g. Bora-Bora sand or Rose de Brignoles sand) or magnesium carbonate; sodium chloride; pumice stone; amorphous silica; diamond; ceramics;
organic particles such as: fruit stones, in particular apricot stones, e.g. Scrubami® apricot; wood cellulose, e.g. ground bamboo stem; coconut shell, e.g. coconut exfoliator; polyamides, in particular Nylon-6; sugars; polyethylenes; polypropylenes; and
mixed particles associating organic and inorganic compounds, and particles coated in the above compounds.

The solid particles may be of shape that is flat, spherical, elongate, polyhedral, or irregular. By way of example, the solid particles may be derived from pumice stone powder grains, diamond powder, powdered fruit stones, powdered coconut shells, microbeads, e.g. microbeads of alumina, glass, or polyamide, in particular Nylon-6, or fibers, in particular polyamide fibers, or hard fibers of wood cellulose.

### Moisturizing Agents

The moisturizing agents are preferably selected from: urea; derivatives of urea such as hydroxyethylurea; polyols such as glycerine; propylene glycol; sorbitol; and polyethylene glycols.

Preferably, the composition of the invention includes at least one anti-dandruff agent or one anti-seborrheic agent. Still more preferably, the composition of the invention includes at least one anti-dandruff agent.

The cosmetic composition for hair that is used in the invention may also contain other compounds that are usual in the field of cosmetics for hair such as: vitamins and pro-vitamins, including panthenol; sun screens; colored or colorless inorganic or organic pigments; pearling and opacifying agents; sequestrating agents; plasticizers; solubilizing agents; anti-oxidants; hydroxyacids; fragrances; non-ionic, anionic, cationic or amphoteric surfactants; non-ionic, anionic, cationic, or amphoteric polymers; short-chain alkanols such as ethanol or isopropanol; acidifying agents; alkalinizing agents; non-silicone solid fats; non-silicone oils; silicones; and preservatives.

The compositions of the invention may be aqueous or anhydrous. They may be in the form of powders, liquids, gels, lotions, creams, and non-powder solids. The may possibly be sprayed onto the scalp via an aerosol or a pump flask.

The method of the invention may be implemented in several variants.

In a first variant, the scalp is massaged by means of the motor-driven device after the composition of the invention has been applied to the scalp.

In a second variant, the scalp is massaged by means of the motor-driven device prior to the composition of the invention being applied to the scalp. In this variant, the massage is performed after the hair and the scalp have been wetted, or after a composition that does not include any active agents of the invention has been applied.

The first variant is preferred. The method of that variant may also include a subsequent step of applying a composition, with or without any active agents of the invention.

The treatment may optionally be followed by a rinse.

Finally, the scalp is dried or left to dry.

The method of the invention may be repeated a plurality of times. In general, the method of the invention is applied once or twice.

The invention may be better understood on reading the following description of non-limiting embodiments thereof, and on examining the accompanying drawings, in which:

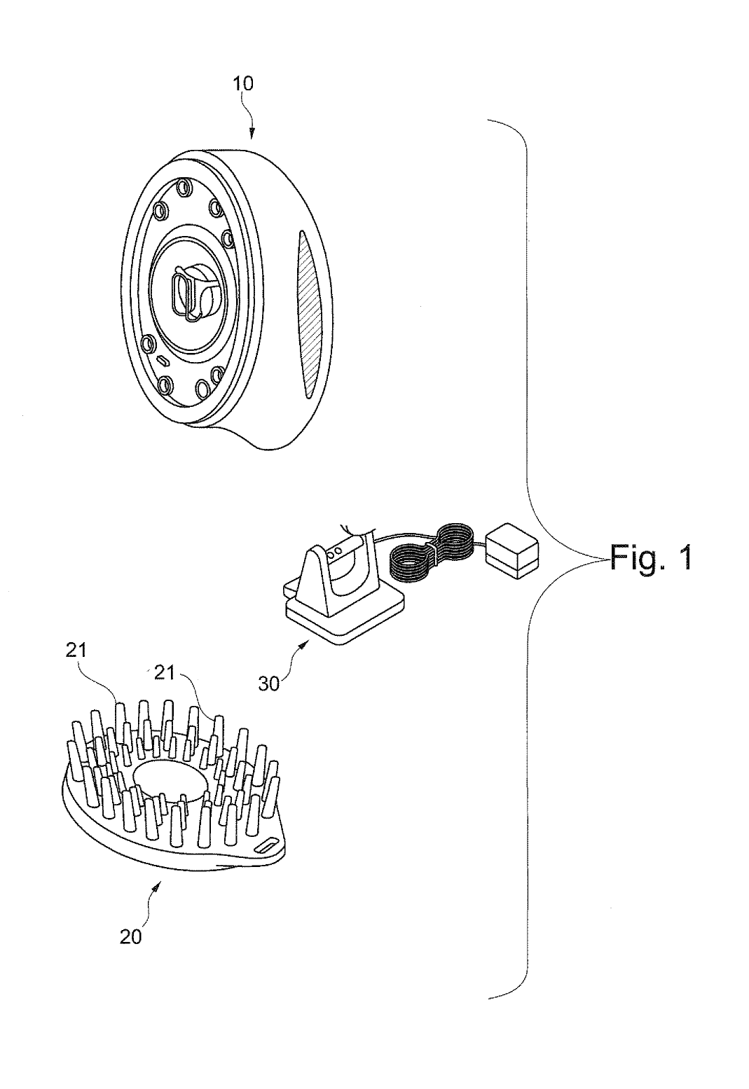

FIG. 1 shows an example of a massage device of the invention;

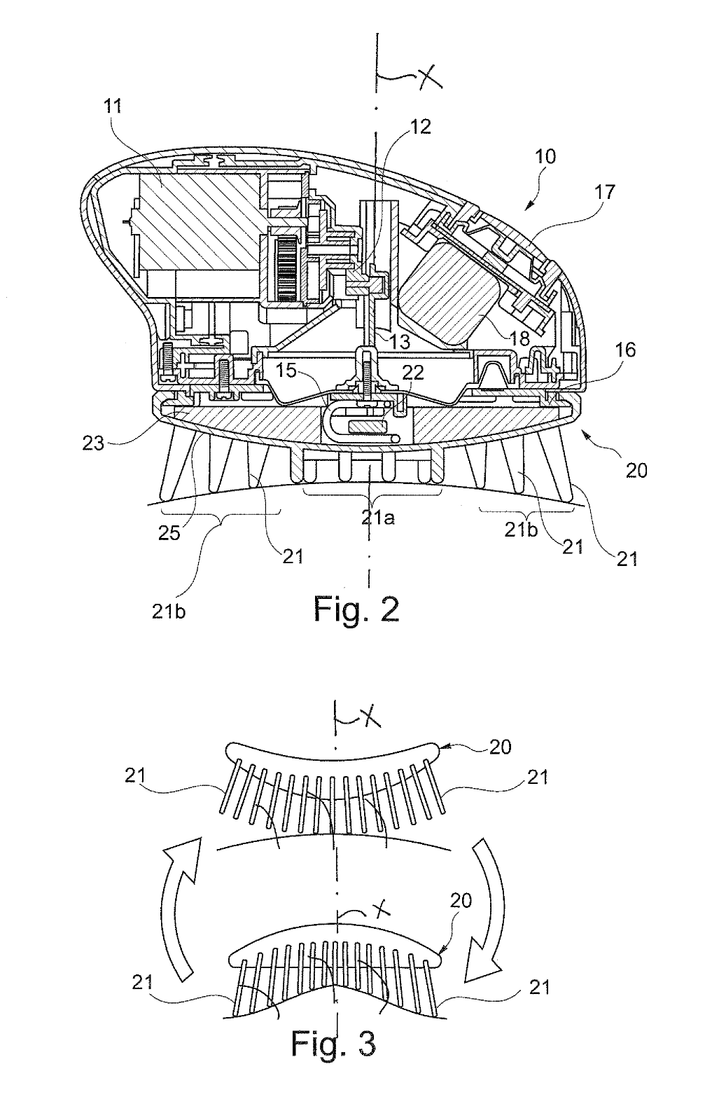

FIG. 2 is a diagrammatic section showing the FIG. 1 device;

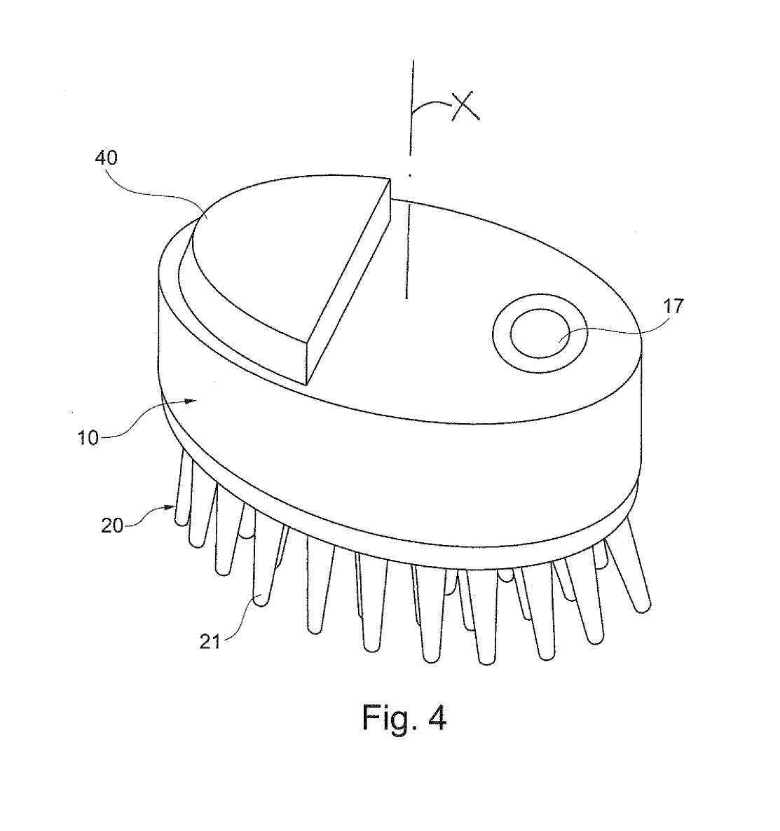

FIG. 3 is a diagram showing the deformation of the diaphragm during operation of the device; and

FIG. 4 is a diagrammatic perspective view showing a variant embodiment of the massage device.

The motor-driven massage device shown in FIGS. 1 and 2 includes a hand piece 10 that can receive a removable diaphragm 20 carrying spikes 21 having free ends for coming into contact with the scalp.

The massage device may be proposed to the user with an electric charger 30, making it possible to recharge a rechargeable battery 18 that is contained in the hand piece 10.

In the embodiment shown, the device is similar to devices sold under the trade name NEO or FLEX by the supplier TWINBIRD, and to the device described in particular in US patent application No. 2009/0182249 A1, with FIG. 2 reproducing a section of that application.

In that figure, it can be seen that the hand piece includes an electric motor 11 and gearbox that rotate a drive member 12 on which there is hinged a connecting rod 13 that is connected to the diaphragm 20, e.g. by means of a hook 15 that is engaged in a portion in relief 22 that is provided on the inside face of the diaphragm 20.

At its periphery, the diaphragm may be fastened onto a rim 16 of the casing of the hand piece 10.

In FIG. 2, it can be seen that a reservoir-forming block 23 of an elastically-deformable porous material may be arranged on the inside face of the diaphragm, but, in a variant, this material is absent. Openings 25, between the spikes 21, may enable communication to take place between the outside of the diaphragm 20 and the block 23.

As shown, the hand piece may include a switch 17 that makes it possible to switch on the electric motor 11, said electric motor being powered by the rechargeable battery 18.

The spikes 21 may present heights that are different, generally being shorter in the central region of the diaphragm and longer at its periphery, so as to give the envelope surface that bears against the free ends of the spikes 21 a shape that is generally concave.

As shown, the spikes 21 may be shared between two groups, namely a first group 21a that is arranged in the central region, having spikes that are oriented parallel to the travel axis X of the portion in relief, and a second group 21b of spikes that are arranged around the first group, having respective longitudinal axes that extend obliquely relative to the axis X, outwards and towards the scalp.

While the device is in operation, the connecting rod 13 is driven in oscillating motion down and up in FIG. 2, thereby causing the diaphragm 20 to deform periodically, the periphery of the diaphragm 20 remaining stationary relative to the hand piece 10, while its central region oscillates along the axis X with maximum amplitude.

As shown in FIG. 3, the oscillations of the diaphragm 20 cause the spikes 21 to rub against the scalp, which rubbing, combined with the use of the composition of the invention, makes it possible to obtain results that are better than when using the composition on its own, or when using the massage device on its own.
1. Regardless of how the drive mechanism for driving the spikes of the massage device is made, it is advantageous that the rubbing of the spikes 21 against the skin periodically massages the skin of the scalp radially inwards and then outwards around the axis X, as shown in FIG. 3. As shown FIG. 3 central axis (X) of the flexible diaphragm (20) may remain perpendicular to the scalp during massage.

In order to use the massage device, the user may apply the composition to the hair, and may massage the scalp with the massage device for a duration lying in the range 1 minute (min) to 5 min, for example. The operator may also comb the hair with the massage device.

### EXAMPLE

The protocol was as follows:
a) a composition with 1% by weight of zinc pyrithione active materials was applied to the hair, e.g. of African or Caucasian type;
b) for 2 minutes, a first side of the head was massaged by hand, and the other side of the head was massaged with the NEO device from the supplier TWINBIRD;
c) rinsing; and then
d) drying.

The results showed that dandruff and scurf washed away better with the method of the invention than by hand, and showed a delay in the reappearance of dandruff and scurf on the scalp treated in accordance with the invention compared with the hand treatment, thus demonstrating durability of the washing effect of the invention.

Steps a) and b) may also be repeated after step c), the protocol then terminating with steps c) and d).

Without going beyond the ambit of the present invention and as shown in FIG. 4, it is possible to use a massage device that includes a removable reservoir 40 containing the composition for application while the massage device is being used to massage the scalp. By way of example, the reservoir 40 may be pre-filled with composition, being supplied to the operator in the form of a cartridge to be placed in the hand piece 10.

By way of example, the composition from the reservoir may be dispensed by means of a pump, e.g. a diaphragm pump, that is actuated by the same motor as the motor that deforms the diaphragm.

The expression “comprising at least one” should be understood as being equivalent to “comprising one or more”.

1. A method of treating a scalp, the method comprising:
applying a composition to a scalp, the composition comprising at least one active ingredient selected from the group consisting of:
an anti-dandruff agent;
an anti-seborrheic agent;
a soothing or anti-irritant agent;
an exfoliating agent;
an anti-hairloss agent; and
a moisturizing agent; and
massaging the scalp with a motor-driven massage device that includes a flexible diaphragm carrying spikes that are adapted to contact the scalp; and a drive mechanism that enables the diaphragm to deform periodically so as to generate an oscillating movement of the spikes in contact with the scalp.

2. The method of claim 1, comprising massaging the scalp with the motor-driven device after applying the composition to the scalp.

3. The method of claim 1, comprising massaging the scalp with the motor-driven device prior to applying the composition to the scalp.

4. The method of claim 1, wherein a frequency of oscillation of the diaphragm is 0.5 Hz to 200 Hz.

5. The method of claim 1, wherein an envelope surface defined by free ends of the spikes is a surface that is concave towards the scalp, having a radius of curvature that varies depending on how the diaphragm deforms.

6. The method of claim 1, wherein a travel axis (X) of the flexible diaphragm is perpendicular to the scalp during the massaging.

7. The method of claim 1, wherein the spikes comprise a thermoplastic material.

8. The method of claim 1, wherein the composition comprises at least one anti-dandruff agent selected from the group consisting of: a derivative of 1-hydroxy-2-pyridone; a pyridinethione salt; triclosan; an azole compound; an anti-fungal polymer; a selenium sulfide; sulfur; cadmium sulfide; allantoin; a coal tar; a wood tar; a derivative of a coal tar; a derivative of a wood tar; undecylenic acid; fumaric acid; an allylamine; ellagic acid; and a trihalogeno carbamide of formula: 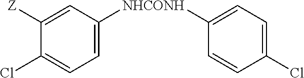
in which Z represents a halogen atom or a C₁-C₄ trihalogenoalkyl group.

9. The method of claim 1, wherein the composition comprises at least one anti-seborrheic agent selected from the group consisting of: retinoic acid; benzoyl peroxide; sulfur; vitamin B6; selenium chloride; sea fennel; a zinc salt; a copper derivative; an extract of a plant or of algae; sebacic acid; glycine grafted onto an undecylenic chain or onto an octanoyl chain; a mixture of oleanolic acid and nordihydroguaiaretic acid; phthalimidoperoxyhexanoic acid; (C₁₂-C₁₃)trialkyl citrate; 10-hydroxydecanoic acid; and a yeast protein hydrolysate.

10. The method of claim 1, wherein the composition comprises at least one anti-irritant or soothing agent selected from the group consisting of: an anti-inflammatory agent; benzydamine; salicylic acid; a strontium salt of salicylic acid; β-glycyrrhetinic acid; glycyrrhizic acid; azulene; an essential oil; an extract of chamomile, oats, aloe vera, verbena, tilia, and licorice.

11. The method of claim 1, wherein the composition comprises an exfoliating agent that includes solid abrasive particles.

12. The method of claim 1, wherein the composition comprises at least one moisturizing agent selected from the group consisting of: urea; a derivative of urea; a polyol; propylene glycol; sorbitol; and a polyethylene glycol.

13. The method of claim 1, wherein the composition comprises at least one anti-hairloss agent selected from the group consisting of: a nicotinic acid ester; 2,4 diamino pyrimidine 3N oxyde; and an O-acyl derivative obtained by partial or total esterification of vitamin F by glucose.

14. The method of claim 1, comprising massaging the scalp for a duration of 1 min to 5 min.

15. The method of claim 1, comprising massaging the scalp in the presence of the composition.

16. The method of claim 1, wherein the composition comprises more than 0.001% of the active ingredient by weight relative to the total weight of the composition.

17. The method of claim 1, wherein a frequency of oscillation of the diaphragm is 1 Hz to 20 Hz.

18. The method of claim 1, wherein the composition comprises more than 0.001% and up to 50% of the active ingredient by weight relative to the total weight of the composition.

19. The method of claim 1, wherein the composition comprises more than 0.1% and up to 50% of the active ingredient by weight relative to the total weight of the composition.

20. The method of claim 1, wherein the composition comprises more than 0.001% and up to 20% of the active ingredient by weight relative to the total weight of the composition.
